(19) United States
(12) Patent Application Publication
(10) Pub. No.: US 2007/0161535 A1
(43) Pub. Date: Jul. 12, 2007

(54) Production of particle-shaped peroxycarboxylic acid compounds

(76) Inventors: Bernhard Orlich, Dusseldorf (DE); Gerhard Blasey, Dusseldorf (DE); Thorsten Bastigkeit, Scottsdale, AZ (US)

Correspondence Address: PAUL & PAUL, 2000 MARKET STREET, PHILADELPHIA, PA, 19103-3229, US

(21) Appl. No.: 11/644,806

(22) Filed: Dec. 22, 2006

Related U.S. Application Data
(63) Continuation of application No. PCT/EP05/06541, filed on Jun. 17, 2005.

(30) Foreign Application Priority Data
Jun. 25, 2004 (DE) 10 2004 030 900.0

(51) Int. Cl. C11D 17/00

(52) U.S. Cl. 510/444; 510/445; 510/446

(57) ABSTRACT

Particles containing imidoperoxycarboxylic acid can be produced by granulating a combination of imidoperoxycarboxylic acid and phlegmatizing agent and optionally granulation auxiliary and subsequently coating the granules with a water-soluble coating material. They can be used as bleaches or bleach component in, in particular, particle-shaped detergents and cleaners and for the production thereof.

### CROSS REFERENCE TO RELATED APPLICATIONS

This application is a continuation under 35 U.S.C. § 365(c) and 35 U.S.C. § 120 of International Application No. PCT/EP2005/006541, filed Jun. 17, 2005. This application also claims priority under 35 U.S.C. § 119 of German Patent Application No. DE 10 2004 030 900.0, filed Jun. 25, 2004. Both the International Application and the German Application are incorporated herein by reference in their entireties.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

(1) Field of the Invention

The present invention relates to a method of producing granules containing organic peroxycarboxylic acid and to the granules produced in this way. Moreover, the present invention relates to the use of these granules as bleaches or bleach component, in particular for their use in, in particular, particle-shaped detergents and cleaners, and for the production thereof.

The particle-shaped bleach components usually used hitherto in solid detergents, such as, for example, alkali metal perborates or percarbonates, are very moisture-sensitive, i.e. they often lose their bleaching effect within a short time on account of the loss of active oxygen since even solid detergents and cleaners always have a certain water content and/or an ingress of water from the air cannot be avoided during storage, if the bleach component is not protected by coating against moisture.

Peroxycarboxylic acids, in particular imidoperoxycarboxylic acids, the most important representative of which is phthalimidoperoxycaproic acid (PAP), are likewise known as bleach component for detergents and cleaners; although these are less hydrolysis-sensitive, their storage stability is also insufficient for ensuring long-term usability of the corresponding detergent or cleaner without accompanying activity loss.

(2) Description of Related Art, Including Information Disclosed Under 37 C.F.R. §§ 1.97 and 1.98

Because of the disadvantages which arise regarding a change in the detergent or cleaner formulation as a consequence of the degradation of imidoperoxycarboxylic acids, in particular PAP, it has been attempted in the prior art to effectively encapsulate the imidoperoxycarboxylic acids (e.g. PAP) so that the imidoperoxycarboxylic acid cannot come into contact with the other components of the detergent or cleaner formulation.

Thus, the European patent specification EP 0 510 761 B1 describes a method of encapsulating detergent additives in general, such as, for example, enzymes, bleach activators, bleach catalysts and bleaches, including PAP, where the protective coating used for the encapsulation is a wax whose melting point is between 40° C. and 50° C. The wax-coated particles are produced here by spraying on the molten wax. In this method, the wax must firstly be heated to temperatures above its melting point, which may be disadvantageous with regard to thermally sensitive substances to be encapsulated. In addition, this method has the disadvantage that the active substance is released only at temperatures above the melting point of the wax used—thus only above temperatures between 40° C. and 50° C.—which in particular does not meet today's consumer or user requirements since—against the background of developing high-performance detergent and cleaner formulations and saving energy costs—washing will often also be done at relatively low temperatures, in particular at about 30° C. In addition, a wax with a high melting point has the disadvantage that it causes residues on the laundry, especially at low temperatures, since it is not completely emulsified at these temperatures.

European Patent Application EP 0 653 485 A1 relates to active-ingredient-containing capsule compositions which can comprise bleaches such as, for example, PAP and in which the active ingredient is present inside the capsule as a dispersion in oil. The production of these capsules, the coating of which is formed from hydrophilic polymers which have only become soluble during the washing operation or use, requires a costly emulsification process which is technologically not easy to carry out.

European Patent Application EP 0 816 481 A2 discloses bleach granules which comprise a peracid such as, for example, PAP and an agglomeration auxiliary in the weight ratio 1:2 to 1:50, and citric acid monohydrate as the exothermy-controlling active ingredient. European Patent specification EP 0 695 343 B1 relates to amidoperoxycarboxylic acid particles which have been coated by spraying on a water-soluble salt in a fluidized bed and comprise less than 2% by weight of water.

### BRIEF SUMMARY OF THE INVENTION

Against this background, the object of the present invention thus consists in providing imidoperoxycarboxylic acids, in particular, phthalimidoperoxycaproic acid (PAP), in storage-stable particulate form in as simple a method as possible.

### BRIEF DESCRIPTION OF THE SEVERAL VIEWS OF THE DRAWING(S)

Not Applicable

### DETAILED DESCRIPTION OF THE INVENTION

This object is achieved by a method of producing particles containing imidoperoxycarboxylic acid by granulating a combination of imidoperoxycarboxylic acid and phlegmatizing agent and optionally granulation auxiliary and subsequently coating with an, in particular, organic water-soluble coating material.

A preferred imidoperoxycarboxylic acid is phthalimidoperoxycaproic acid. This is known, for example, from European patents EP 0 349 940 and EP 0 325 328. It is commercially available in water-containing form as so-called “wet cake,” as is produced in the course of its production from aqueous systems normally in relatively large crystals, which can cake together. In this form or in any other particulate form, for example, as finely ground powder, it can serve as starting material for the method according to the invention. Amounts of imidoperoxycarboxylic acid of up to 80% by weight, in particular, 50% by weight to 70% by weight, in each case based on the overall particle, are preferred. As a consequence of the production, minor amounts of the corresponding imidocarboxylic acid may also be present in the imidoperoxycarboxylic acid used; these do not have to be removed to carry out the method according to the invention.

The phlegmatizing agent, which may be anhydrous or in hydrate form, is preferably chosen from aluminum sulfate, aluminum oxide, boric acid, citric acid, the alkali metal borates, the alkali metal citrates and mixtures thereof. Mixtures of boric acid and citric acid and mixtures of citric acid and aluminum sulfate and/or aluminum oxide, and optionally alkali metal citrate are particularly preferred. Sodium is the preferred alkali metal. The phlegmatizing agent is preferably used in powder or particulate form of customary particle size. Amounts of phlegmatizing agent of from 5% by weight to 30% by weight, in particular 10% by weight to 20% by weight, in each case based on the overall particle, are preferred.

The optionally used granulation auxiliary is preferably chosen from nonionic surfactants, anionic surfactants, polymeric glycols, polymers and copolymers of acrylic acid, methacrylic acid and/or maleic acid, which may also be present in the form of their sodium, potassium or ammonium salts, and mixtures thereof. The binder is preferably used as aqueous solution, which in particular has a water content of from 30% by weight to 80% by weight. Amounts of granulation auxiliary of up to 2.5% by weight, in particular 1% by weight to 2% by weight, in each case based on the overall particle, are preferred.

In a preferred embodiment of the invention, the combination of imidoperoxycarboxylic acid and phlegmatizing agent and optionally granulation auxiliary to be granulated additionally comprises a water-binding powdering agent, in particular silica (for example, commercially available under the name Aerosil® 200). Amounts of powdering agent of up to 7.5% by weight, in particular 1% by weight to 5% by weight, in each case based on the overall particle, are preferred.

Optionally, the combination to be granulated can also comprise further substances which are inert to the specified essential ingredients, for example, alkali metal sulfates, alkali metal carbonates or the like, in small amounts up to, for example, about 10% by weight, in each case based on the overall particle.

The granulation is preferably carried out by an agglomeration step and/or a compaction step. The agglomeration step is preferably carried out in a granulation mixer or a fluidized-bed apparatus. The compacting step is preferably carried out with the help of a roller press or an extruder. In the method, the pressures applied are preferably such, and/or the granules are preferably removed from the mixer or the fluidized bed after times such that the resulting granules have a bulk density in the range from 400 g/l to 1,000 g/l, in particular 450 g/l to 800 g/l.

The coating step according to the invention is preferably carried out at temperatures not exceeding 80° C., with cooling to below room temperature normally not being necessary. Among the water-soluble coating materials, preference is given to those which in aqueous solution, in particular at the concentration at which they are used in the method according to the invention, have a pH below 7. They preferably contain no halide ions. Suitable coating materials, on their own or in a mixture with one another, are inorganic salts such as sodium sulfate, but preferably organic materials, in particular long-chain fatty alcohol ethoxylates, polymeric polyols such as polyethylene glycol, polyvinylpyrrolidone, polyvinyl alcohol and polymeric polycarboxylates, in particular polymerization products of acrylic acid, methacrylic acid or maleic acid or copolymers of at least two of these, where the acids specified may also be used in completely or at least partially neutralized form, in particular in the form of the alkali metal salts. Standard commercial products are, for example, Sokalan® CP 5, CP 10, CP 45 and PA 30 from BASF. These, particularly if they are long-chain fatty alcohol ethoxylates or polyethylene glycol, can, if desired, be used as melts, although in a preferred embodiment of the method according to the invention the coating materials are applied in aqueous solution to the granulation product obtained in the first process part-step, it being advantageous in the preferred case if drying also takes place at the same time. This can be achieved in a simple manner through the use of a fluidized-bed drying device in which an aqueous coating material solution is sprayed onto a fluidized bed of the granulation product obtained in the first process part-step, and the water is at least largely removed by air as fluidizing agent. Inlet air temperatures in the range from about 30° C. to 50° C. are normally highly suitable for this. If the granulation step has already been carried out in a fluidized-bed apparatus, the coating step can preferably be undertaken in the same apparatus, possibly without having to remove the intermediate product from the fluidized bed beforehand. The coating step usually does not significantly change the bulk density. If desired, the coating can also take place in a plurality of layers, with possibly in each case a different composition of the individual layers. The application of dyes is also possible where, in this case, the coating preferably consists of a plurality, in particular two, layers and only the outermost layer contains the dye.

Furthermore, a particle produced according to the invention can comprise disintegration auxiliaries, for example cellulose. This can be incorporated into the combination of imidoperoxycarboxylic acid and phlegmatizing agent to be granulated and/or into the coating layer. Amounts of disintegration auxiliary of up to 2% by weight, based on the overall particle, are preferred.

If desired, a particle produced according to the invention can be powdered after the coating step with a finely divided powdering agent, for example silica.

Particles obtainable in this way are preferably used as bleaches or bleach component, in particular, in particle-shaped detergents and cleaners, and for the production thereof. Particle-shaped detergents or cleaners which comprise a particle obtainable by the method according to the invention preferably have a bulk density in the range from 400 g/l to 1000 g/l, and comprise the specified particle preferably in amounts of from 0.1% by weight to 10% by weight.

### EXAMPLE 1

The following formulation was granulated in a Schlüter edge mill grinding press (pelleting press PP 127-3.0; Maschinenfabrik Schlüter) with a throughput of 30 kg/h at a press roller speed of 100 rpm:

| | |
|---|---|
| Eureco ® W (63% PAP) | 79% |
| Boric acid | 20% |
| PEG4000 | 1% |

The following processing parameters were used: 1.4 mm perforated plate; distance between perforated plate and roller 1 mm.

After the granulation, the preformulated material was dried at an inlet air temperature of 40-50° C. in an Aeromatik fluidized bed and additionally coated with 10% PEG4000 (20% strength PEG solution sprayed on by means of a dual-material nozzle).

The following data were determined analytically for the resulting granules:

| | Content |
|---|---|
| PAP | 60.9% |
| Degradation product PAC | 7.1% |
| Water | 7.8% |
| Degree of preservation PAP: | 96% |

### EXAMPLE 2

Premix for the Extrusion:

| | |
|---|---|
| PAP (Eureco ® W) | 72% |
| Boric acid | 18.7% |
| Lipoxol 4000 | 4.7% |
| Sodium sulfate | 4.6% |

The premix for the extrusion in the twin-screw extruder with chopping device (particle size 1.4 mm) was metered at 30 kg/h. Extruder: Lihotzky Maschinenfabrik GmbH & Co KG, laboratory extruder LTW 63.

Temperature in the extruder: 22° C.

Pressure in the extruder: start-up: 13 bar; steady-state: 2 bar.

Drying of the particles in the fluidized-bed dryer (analogous to Example 1) at 40° C. to a water content of about 7%, then coating with an aqueous suspension (PEG4000) and drying.

The following contents were determined analytically in the resulting granules:

| | After extruder | After coating |
|---|---|---|
| PAP | 46.6% | 52.6% |
| Degradation product PAC | 5.4% | 7.1% |
| Water | 26.5% | 11.5% |
| Degree of preservation PAP: | 96% | 94% |

### EXAMPLE 3

| A premix of PAP, citric acid, | | | | |
|---|---|---|---|---|
| Sokalan ® CP45 and Aerosil ® | | | | |
| 200 (silica) was prepared, | | | | |
| which was combined in a mixer. | | | | |
| Drying and simultaneous coating | | | | |
| were then carried out in a | | | | |
| fluidized bed at a moderate | | | | |
| inlet air temperature (coating = | | Before | After | After |
| 20% strength PEG4000 solution). | Premix | drying | drying | coating |
| PAP from Eureco W | 70.00% | 55.56% | 66.04% | 62.74% |
| H2O from Eureco W | 20.00% | 15.87% | 0.00% | 0.00% |
| Remainder from Eureco W | 10.00% | 7.94% | 9.43% | 8.96% |
| CP45 pH 5 for AS granulation | 1.00% | 0.79% | 0.94% | 0.90% |
| Boric acid/citric acid | 20.00% | 15.87% | 18.87% | 17.92% |
| Aerosil ® 200 | 5.00% | 3.97% | 4.72% | 4.48% |
| Coating | | | | 5.00% |

The degree of preservation of the peracid during the entire process was 96-100%. If alternatively to the mixer in accordance with Example 2 or Example 1 the premix was pre-formulated in the extruder or the roller press, no significant differences arose.

1. A method of producing particles comprising the steps of: (1) granulating a composition comprising imidoperoxycarboxylic and phlegmatizing agent and an optional granulation auxiliary and (2) coating the granules obtained in step (1) with a water-soluble coating material.

2. The method of claim 1 wherein step (1) is carried out by agglomeration, compaction or a combination thereof.

3. The method of claim 1 wherein the imidoperoxycarboxylic acid is phthalimidoperoxycaproic acid.

4. The method of claim 1 wherein the phlegmatizing agent is selected from the group consisting of boric acid, citric acid, aluminum sulfate, aluminum oxide, an alkali metal borate, an alkali metal citrate and mixtures thereof wherein the phlegmatizing agent is in the anhydrous or the hydrate form.

5. The method of claim 1 wherein the composition of step (1) is further comprised of a granulation auxiliary selected from the group consisting of a nonionic surfactant, an anionic surfactant, a polymeric glycol, a homopolymer or copolymer of acrylic acid, methacrylic acid and/or maleic acid and/or the sodium, potassium and/or ammonium salts thereof.

6. The method of claim 1 wherein the composition of step (1) is further comprised of a water-binding powdering agent.

7. The method of claim 1 wherein the amount of imidoperoxycarboxylic acid is up to 80% by weight.

8. The method of claim 7 wherein the amount of imidoperoxycarboxylic acid is from 50% T by weight to 70% by weight based on the overall particle weight.

9. The method of claim 1 wherein the amount of phlegmatizing agent is from 5% by weight to 30% by weight based on the overall particle weight.

10. The method of claim 9 wherein the amount of phlegmatizing agent is form 10% by weight to 20% by weight.

11. The method of claim 1 wherein the amount of the auxiliary is up to 2.5% by weight based on the overall particle weight.

12. The method of claim 1 wherein the amount of the auxiliary is from 1% by weight to 2% by weight.

13. The method as claimed in claim 1, characterized in that the granulation involves a compacting step which is carried out with the help of a roller press or an extruder.

14. The method of claim 1 wherein step (1) is carried out at a pressure such that the resulting granules have a bulk density in the range from 400 g/l to 1000 g/l.

15. The method of claim 14 wherein the bulk density is from 450 g/l to 800 g/l.

16. The method of claim 1 wherein step (1) is carried out in a mixer or a fluidized-bed apparatus.

17. The method of claim 16 wherein step (1) is carried out for a time period such that the resulting granules have a bulk density in the range from 400 g/l to 1000 g/l.

18. The method of claim 17 wherein the bulk density is from 450 g/l to 800 g/l.

19. A particle-shaped detergent or cleaner produced by the method of claim 1.

20. The particle of claim 19 having a bulk density is from 450 g/l to 800 g/l.
